(19) United States
(12) Patent Application Publication
(10) Pub. No.: US 2013/0056300 A1
(43) Pub. Date: Mar. 7, 2013

(54) Apparatus and Methods to Reduce Downspout Noise

(71) Applicants: Max H. Corrales, San Jose, CA (US); Michael Arnold Stark, San Jose, CA (US)

(72) Inventors: Max H. Corrales, San Jose, CA (US); Michael Arnold Stark, San Jose, CA (US)

(73) Assignee: StaCor Products, San Jose, CA (US)

(21) Appl. No.: 13/405,342

(22) Filed: Feb. 26, 2012

Related U.S. Application Data
(60) Provisional application No. 61/447,021, filed on Feb. 26, 2011.

(51) Int. Cl. F16L 55/02

(52) U.S. Cl. 181/233; 181/296

(57) ABSTRACT

In one embodiment, the present invention includes an apparatus to reduce downspout noise. The apparatus includes a first and second portion. The first portion has a first diverting angle relative to the water flowing through the downspout. The second portion is coupled to the first portion and has a second diverting angle relative to the water flow. The second angle is greater than the first angle, thereby providing incremental diversion of the water flow. At least a portion of the surfaces may also include a surface detail to provide micro-diversions of the water flow. The diversions of the water may reduce the impact of the water flow and reduce downspout noise.

### CROSS REFERENCE TO RELATED APPLICATIONS

The present application claims priority to U.S. Provisional application titled “Apparatus and Methods to Reduce Downspout Noise”, filed Feb. 26, 2011.

### BACKGROUND

The present invention relates to reducing downspout noise, and in particular, to apparatus and methods to reduce downspout noise.

Most constructed buildings include some sort of drainage system. The most common drainage system consists of a connection of drain gutters and downspouts connected to collect and channel water away from the building. Depending on their construction, the movement of water through these pipes may cause extraneous sounds.

Sounds may emanate from water impacting on diverting portions of the downspouts. For example, a downspout may be connected to a rain gutter to collect and drain water down the downspout. The end of the downspout may be impacted by this water as the water is diverted away from the building. This impact may cause at least a portion of the downspout to resonate with a sound. This sound may be caused by a wide variety of flows passing in the downspout. For example, a slow drip may impact the down spout to cause a noise which may be audible from inside the building. This noise may be disruptive to activities within the building, such as sleeping, for example.

### SUMMARY

Embodiments of the present invention reduce extraneous noise from a downspout. In one embodiment of present invention includes an apparatus to reduce extraneous noise from a downspout. The apparatus includes a first portion having a first diverting angle relative to a water flow through the downspout and a second portion coupled to the first portion and having a second diverting angle relative to the water flow. The second angle is greater than the first angle, thereby providing incremental diversion of the water flow.

In one embodiment, the apparatus further includes a micro diversion portion coupled to at least the second portion. The micro diversion portion includes surface features which disperse a force of the impact of the water flow.

In another embodiment, the apparatus further includes protrusions located on the surface of at least one portion of the apparatus. The protrusions act as micro diversions of the water flow.

In yet another embodiment, the first portion includes at least one break away location to adjust a length of the first portion.

In one embodiment, the apparatus further includes a third portion coupled between the first and second portions. The third portion forms an angle between the first and second portion which allows the first portion to reach up into a vertical section of the downspout.

In another embodiment, the apparatus further includes a fourth portion coupled to the second portion. The fourth portion includes at least one clip to attach the apparatus. The first and second diversion angles are formed when at least the third portion flexes in response to a force between the first portion on a back of the downspout and the fourth portion on a lip of the downspout.

The following detailed description and accompanying drawings provide a better understanding of the nature and advantages of the present invention.

### BRIEF DESCRIPTION OF THE DRAWINGS

FIG. 1A-C illustrate an apparatus according to one embodiment of the present invention.

FIG. 2A-C illustrate an apparatus according to another embodiment of the present invention.

FIG. 3A-D illustrate an apparatus according to yet another embodiment of the present invention.

### DETAILED DESCRIPTION

Described herein are techniques for apparatus to reduce downspout noise. In the following description, for purposes of explanation, numerous examples and specific details are set forth in order to provide a thorough understanding of the present invention. It will be evident, however, to one skilled in the art that the present invention may include some or all of the features in these examples alone or in combination with other features described below, and may further include modifications and equivalents of the features and concepts described herein.

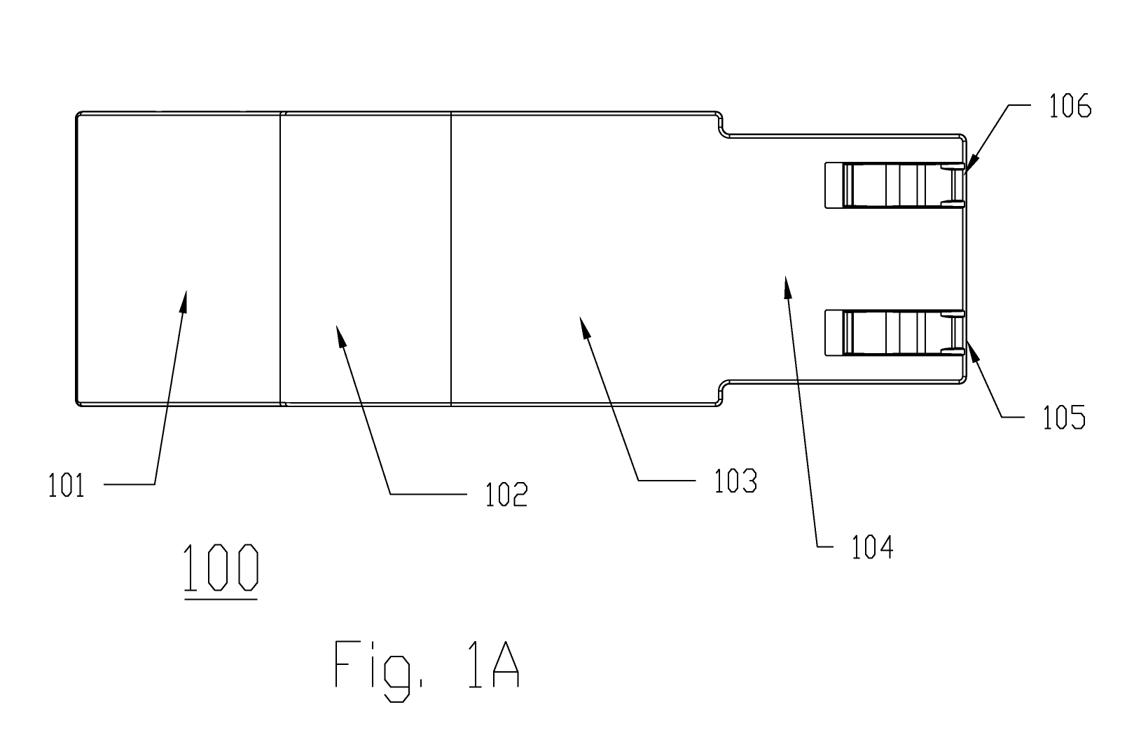

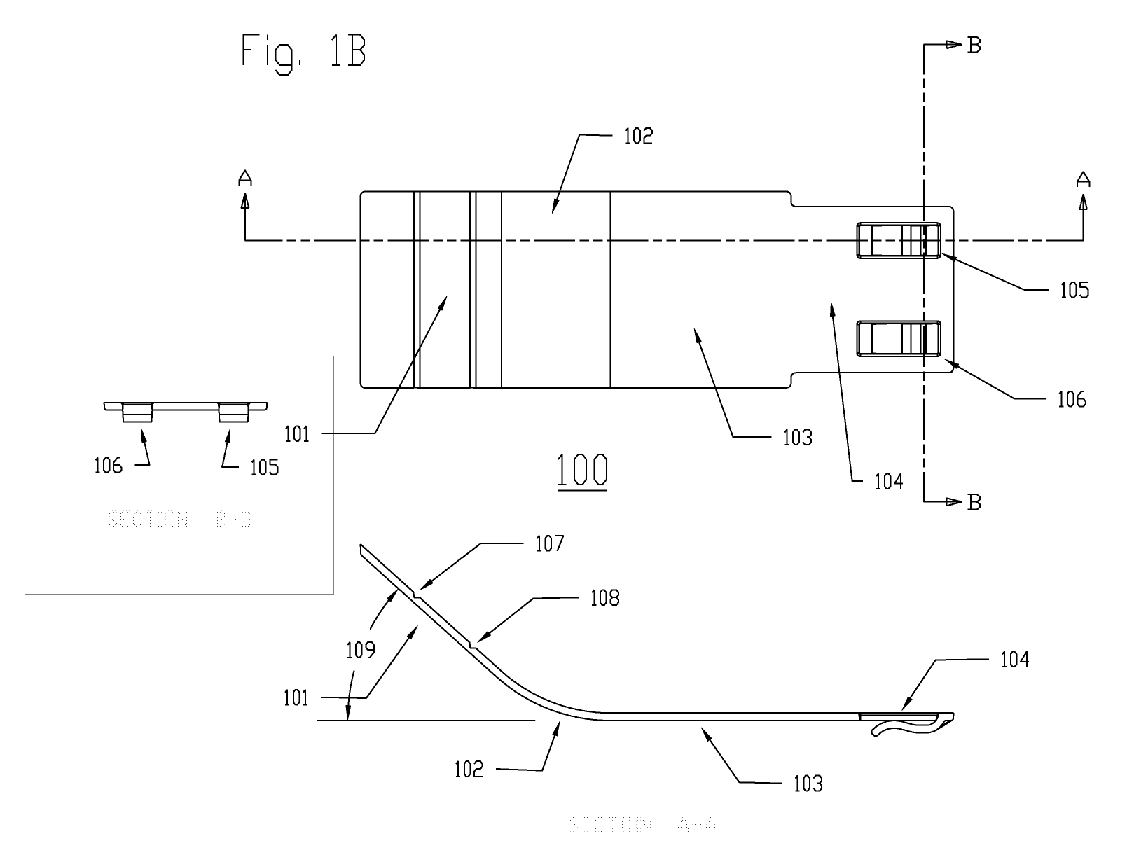

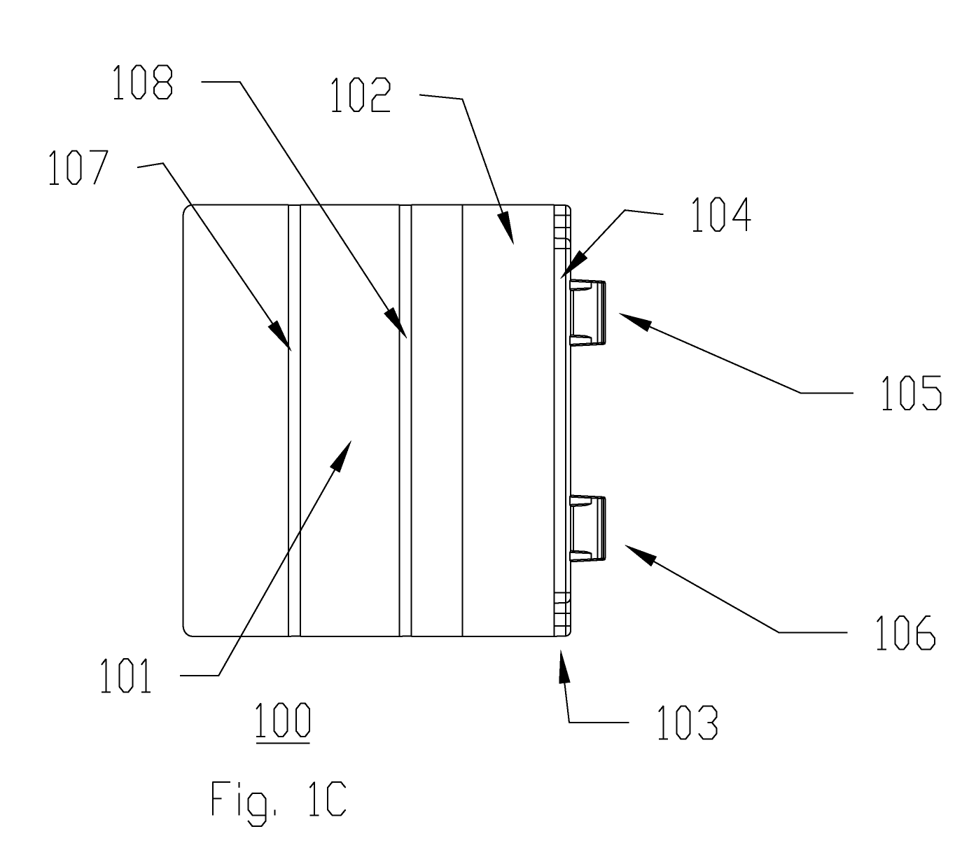

FIGS. 1A-C illustrate an apparatus 100 according to one embodiment of the present invention. Apparatus 100 includes a body having portions 101-104. FIG. 1A illustrates a bottom view of apparatus 100 showing portions 101-104. FIG. 1B illustrates a top view, a side view (A-A view) and a section B-B view, and FIG. 1C illustrates a front view of apparatus 100. When inserted into the end of a downspout, apparatus 100 may reduce the noise associated with the diversion of water and debris out of a downspout.

As shown in FIG. 1A, portion 101-104 of apparatus 100 may be formed into a single continuous piece of material. Apparatus 100 may also include clips 105-106 at the end of portion 104. When inserted into a downspout, portion 101 may be set against a back wall of the downspout while clips 105-106 may be fastened to the outer lip of the downspout.

FIG. 1B shows a section view A-A that illustrates an angle 109 between portion 101 and 103. Portion 102 may be curved and couple sections 101 and 103. Angle 109 allows section 101 to reach up into the vertical section of the downspout when inserted. Angle 109 may be approximately a 42 degree angle. The insertion angle of section 101 may allow water flow to be slightly diverted such that the energy of the water is slightly reduced without causing a significant impact and/or extraneous noise. When inserted, apparatus 100 may slightly flex such that portion 102 is slightly elevated from the bottom of the downspout and portion 103 may be tilted downward to the lip of the downspout which may be clipped by clips 105-106. Portion 101 may have a smaller diversion angle (with respect to vertical water flow) than portion 103 allowing at least two surfaces which progressively slow the flow of the water through the downspout. The flexing of apparatus 100 may also put a force on the clips making a more secure fit within the downspout.

FIG. 1B shows section view B-B that illustrates the spacing of clips 105-106 in relation to the width of portion 104. Portion 104 may be more narrow than portions 101-103 in order to allow some flex between section 103 and 104. The width of the clips limits the force required to insert apparatus 100 into an inserted position within a downspout. The length of the clips may allow for a more secure attachment of portion 104 to the bottom of the downspout by placing the force further to the center of portion 104.

FIG. 1B illustrates break away locations 107-108. Locations 107-108 are located along the width of portion 101 and form lines in which the material is less thick. These locations may be formed from an original mold or be scored after molding. Locations 107-108 allow the length of portion 101 to be adjusted according to the depth of the downspout. Sections may be broken away at locations 107-108 in order that portions 101-104 form a length allowing appropriate angles in an inserted position within a downspout. This feature may also be valuable in making sure a sufficient force exists between portion 101 and 104 in an inserted position within a downspout.

FIG. 1C illustrates a front view of apparatus 100. Break away locations 107-108 are shown on portion 101. Also portions 102-104 are shown along with clips 105-106. Portion 104 may be seen as narrower than portions 101-103. The thickness of apparatus 100 may be adjusted according to the material used in order to obtain a stiffness and flexibility to allow for manual insertion of apparatus 100 within the downspout while providing sufficient force to maintain the insertion position.

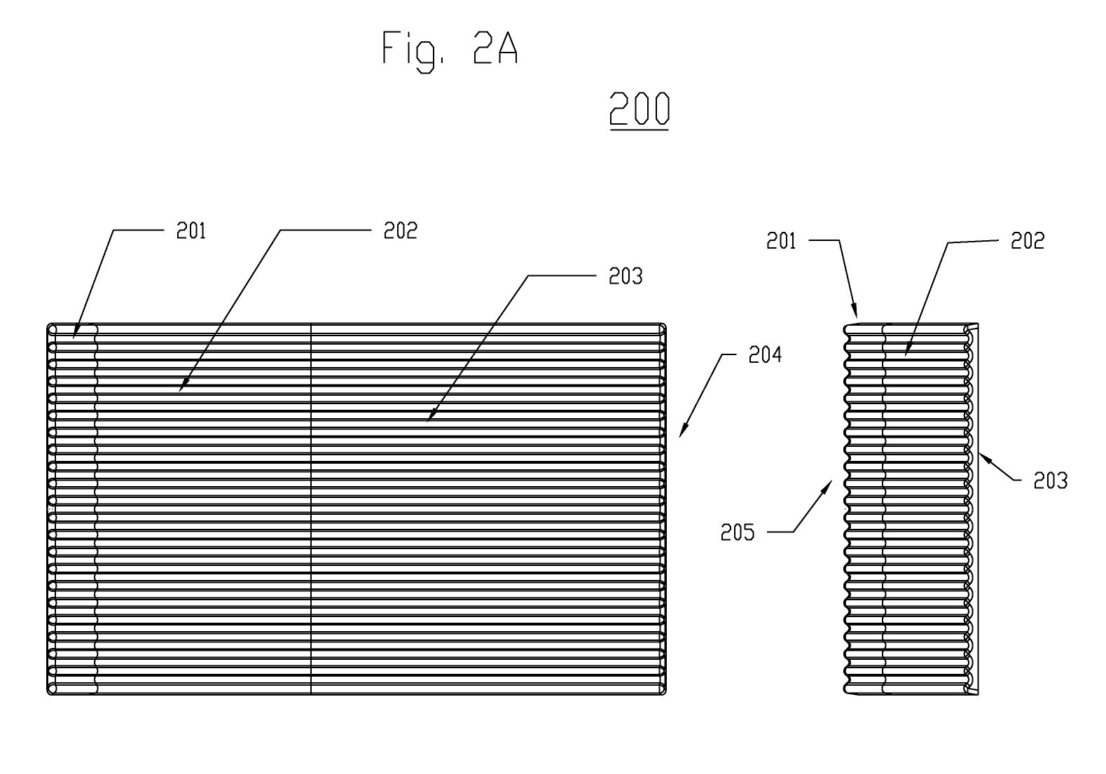

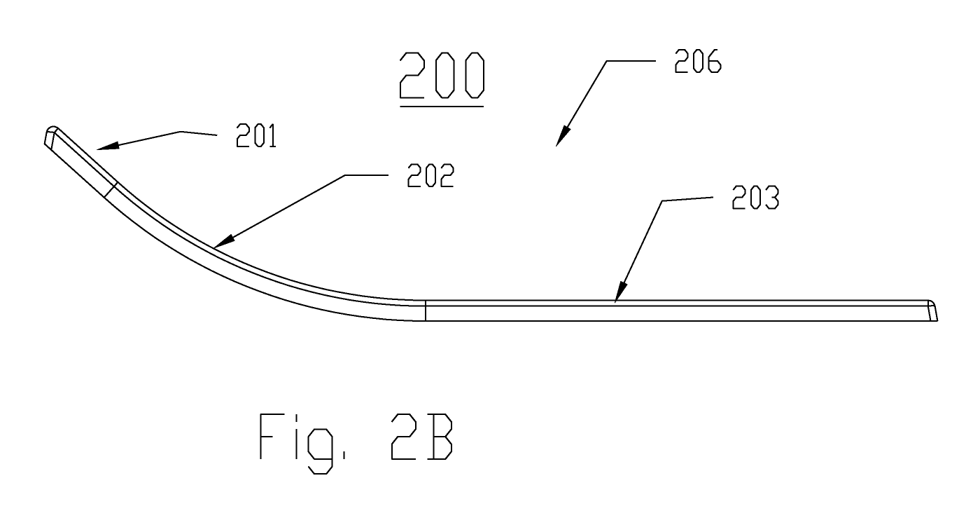

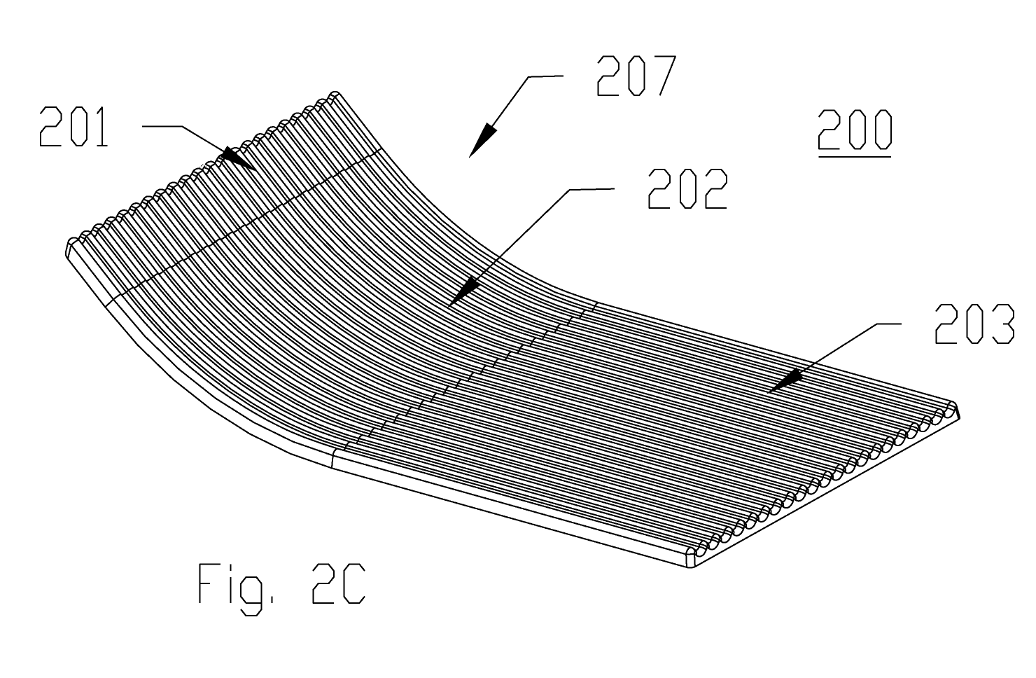

FIG. 2A-C illustrate an apparatus according to another embodiment of the present invention. FIG. 2A illustrates a top view 204 and front view 205, FIG. 2B illustrates a side view 206, and FIG. 2C illustrates a three dimensional view 207. Top view 204, front view 205, and side view 206 all show portions 201-203. Side view 207 shows portion 202 curving up and placing portion 201 at an angle relative to portion 203. Apparatus 200 includes surface features on its top portion which may aid in spreading or dispersing the force of the impacting water across a wider surface.

In this embodiment the surface resembles furrows along the length of the body of apparatus 200. These furrows may act as sound dissipaters. As water comes into contact with vertical elongated protrusions, the water is diverted to the sides and into the furrows. The vertical elongated protrusions dissipate a portion of the moving water over an increased time. For portion 101 which is at an angle already, the contact time may be extended such that less water splashes to the sides of the downspout. The furrows also aid in the diversion of debris by reducing the vertical obstructions to debris passage and maintaining clear furrows to continue micro diversion of the water. Dimpled, amorphous, knurled, pimpled, smooth, and bumpy surfaces may be used with varying degrees of sound dampening and debris passage.

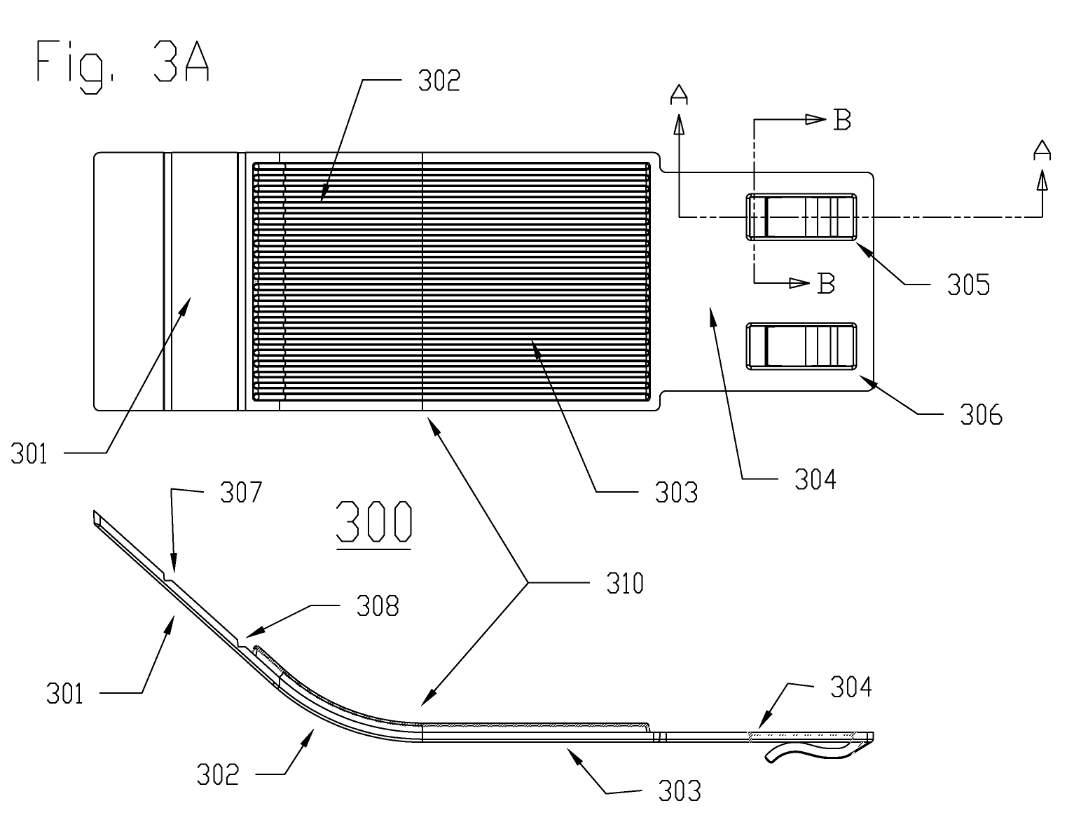

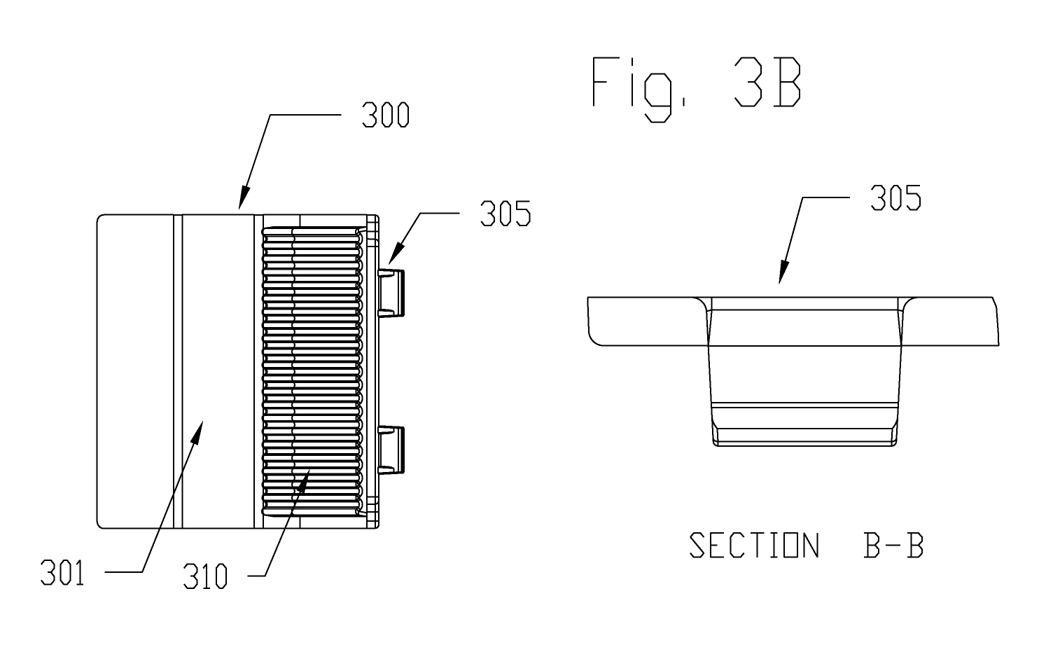

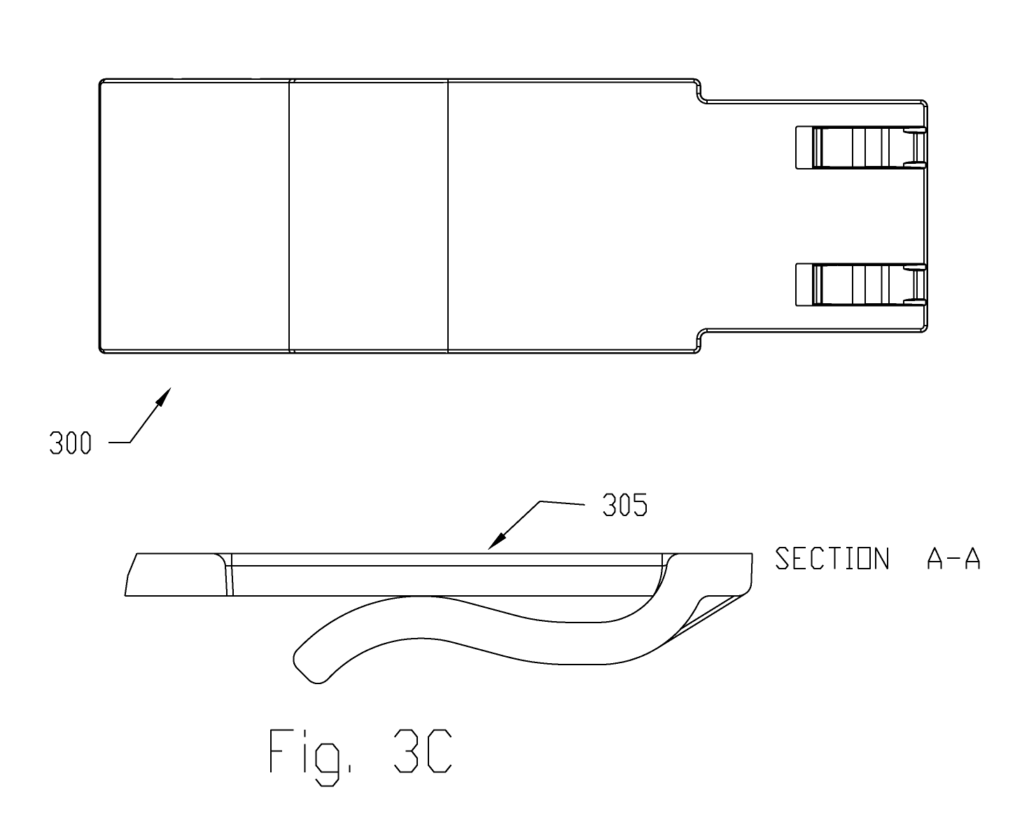

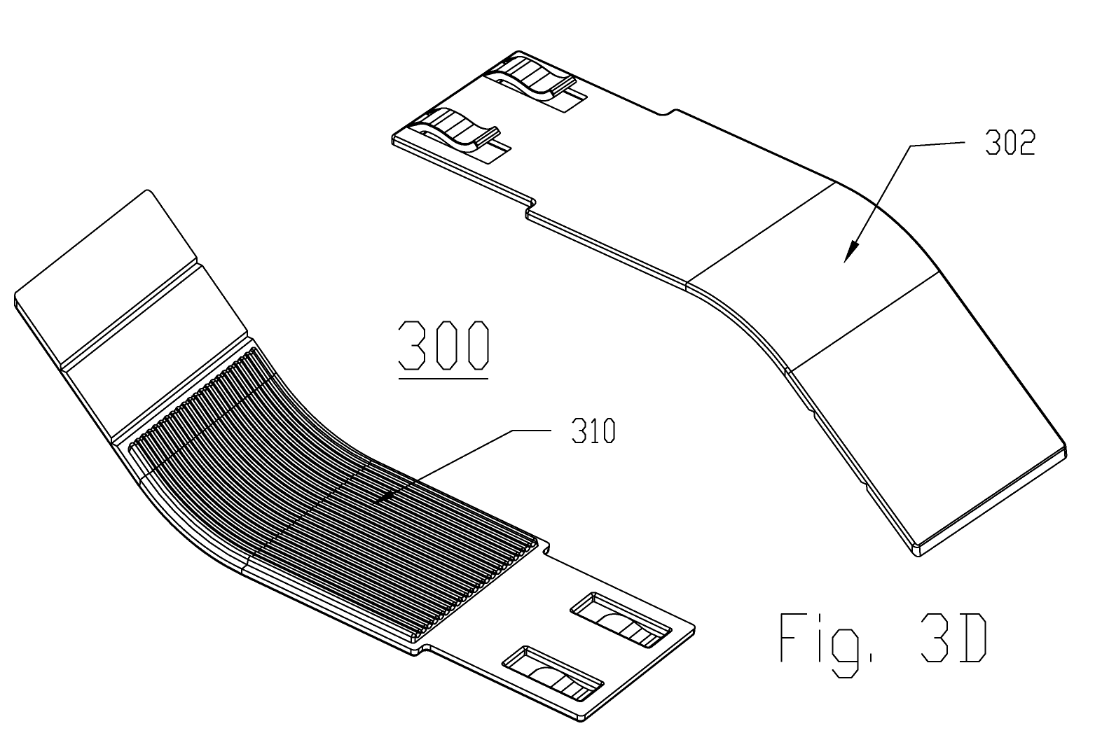

FIG. 3A-D illustrate an apparatus 300 to according to yet another embodiment of the present invention. FIG. 3A illustrates a top view and a side view of apparatus 300. FIG. 3B illustrates a front view and a section B-B view of apparatus 300, and FIG. 3C illustrates a bottom view and a section A-A view of apparatus 300. FIG. 3D illustrates two 3-dimensional views of apparatus 300. Apparatus 300 includes portions 301-304 contributing to macro diversion of the water flow and portion 310 contributing to micro diversion of water flow. These portions may contribute to reducing the impact of the water and reducing noise.

Apparatus 300 is similar to apparatus 100 of FIG. 1A-1C. Portions 101-104, break away locations 107-108, and clips 105-106 of FIGS. 1A-C are similar to portions 301-304, break away locations 307-308 and clips 305-306 of FIGS. 3A-D, respectively. Apparatus 300 also includes a portion 310 for micro diversion. Portion 310 is similar to portion 201-203 of apparatus 200 of FIG. 2A-C. Portion 310 may be formed along with portion 301-304 or may be formed separately and attached. Portion 310 may be formed or constructed of a material which is less rigid than the material formed/constructed for portions 301-304. Portion 310 may be treated after formation or during processing in order to obtain a less rigid characteristic. Portion 300 may micro-divert the flow of the water due to the shape of the protrusions and the give in (e.g. the elasticity of) the material of the protrusions.

FIG. 3B illustrates a front view of apparatus 300 showing portion 310. Portion 310 may cover some of portion 301. This may be done in order to allow for easier break away action before final insertion into a downspout. Portion 301 is at an upward angle when in the inserted position within a downspout and may divert the water flowing along the backside of the downspout.

FIG. 3B section B-B and FIG. 3C section A-A illustrate clip 305 of apparatus 300. Section B-B shows the width of clip 305 and the taper and curve of the clip. Section A-A of FIG. 3C shows the length of clip 105 and the bend and curve of the clipping end of clip 305. The clipping end shows a contact point well within the edge of apparatus 300. The thickness of clip 305 may be commensurate with the thickness of portion 304. This thickness may be designed to provide a strong clipping action without restricting a smooth insertion of clip 305 onto the lip of a downspout opening.

The insertion of apparatus 300 may be accomplished by inserting apparatus 300 into a downspout opening with portion 301 being inserted first and apparatus 300 having portion 310 facing up. Portion 303-304 may be tilted higher than portion 302 in order to insert portion 301 directly. Next, portion 301 is pushed to the rear wall of the downspout and portion 304 is allowed to slide on the bottom lip of the downspout opening. If the length of the apparatus is too great and not allowing clips 305-306 to engage on the lower lip, then apparatus 300 may be removed and a break-away location may be used to adjust the length of apparatus 300 and then the apparatus may be reinserted as before. Iterations may be needed to get the correct length established.

Apparatus 300 may be clipped into place with a tension between portion 301 and clips 305-306. In the inserted position, apparatus 300 may have portion 303 at a slight angle relative to a horizontal earth surface, and portion 301 may be at a greater angle relative to the horizontal earth surface. These angles allow for macro diversion of water while the surface detail of portion 310 allows for micro diversion of water. These diversions may dissipate the energy of the water flowing incrementally by increasing the contact area and/or increasing the time in contact with the overall surface of apparatus 300. These diversions may reduce the impact noise associated with the water flow.

In one embodiment, the apparatus includes a first surface having a first diverting angle relative to water flowing through a downspout and a second surface coupled to the first surface and having a second diverting angle relative to the water flow. The second angle is greater than the first angle and thereby incrementally increasing a diversion angle of the water flow. In another embodiment, the invention includes a third surface forming a curve between the first and second surface to provide a smooth flow of water and debris.

In yet another embodiment, at least a portion of the first and second surfaces has a surface detail. The surface detail provides micro-diversions to the water flowing. In another embodiment, the surface detail includes furrows and protrusions along at least a portion of the length of the apparatus. The furrows and protrusions micro-divert the water flow. In yet another embodiment, the surface detail micro-diverts the water flow in a plurality of directions corresponding to a curve of the surface detail.

The above description illustrates various embodiments of the present invention along with examples of how aspects of the present invention may be implemented. The above examples and embodiments should not be deemed to be the only embodiments, and are presented to illustrate the flexibility and advantages of the present invention. Based on the above disclosure, other arrangements, embodiments, implementations and equivalents will be evident to those skilled in the art and may be employed without departing from the spirit and scope of the invention.

What is claimed is:

1. An apparatus to reduce extraneous noise from a downspout, said apparatus comprising:
a first portion having a first diverting angle relative to a water flow through said downspout; and
a second portion coupled to said first portion and having a second diverting angle relative to said water flow,
wherein said second angle is greater than said first angle, thereby providing incremental diversion of said water flow.

2. The apparatus of claim 1 further comprising a third portion coupled between said first and second portions, said third portion forming an angle which allows said first portion to reach up into a vertical section of said downspout.

3. The apparatus of claim 2 wherein said third portion flexes as said second portion is elevated to said second diversion angle when said apparatus is inserted into said downspout.

4. The apparatus of claim 1 further comprising at least one clip coupled to said second portion, said at least one clip attaching to a lip of said downspout such that said first portion sets against a back wall of said downspout.

5. The apparatus of claim 4 wherein said apparatus flexes in response to a force exerted between said at least one clip and said first portion setting on said back wall of said downspout, said force thereby making a more secure fit within said downspout.

6. The apparatus of claim 1 further comprising a micro diversion portion coupled to at least said second portion, said micro diversion portion includes surface features which disperse a force of the impact of said water flow.

7. The apparatus of claim 6 wherein said micro diversion portion is less rigid than said second portion.

8. The apparatus of claim 1 further comprising protrusions located on the surface of at least one portion of said apparatus, said protrusions act as micro diverters of said water flow.

9. The apparatus of claim 8 wherein said protrusions include furrows which aid in the passage of debris thereby maintaining said furrows clear to continue micro diversion of said water flow.

10. The apparatus of claim 1 wherein said first portion includes at least one break away location to adjust a length of said first portion.

11. A method comprising:
diverting a water flow through said downspout with a first portion of an apparatus having a first diverting angle relative to said water flow; and
further diverting said water flow with a second portion of said apparatus coupled to said first portion and having a second diverting angle relative to said water flow,
wherein said second angle is greater than said first angle, thereby providing incremental diversion of said water flow.

12. The method of claim 11 further comprising flexing a third portion of said apparatus which is coupled between said first and second portions, wherein said second portion is elevated to said second diversion angle when said apparatus is inserted into said downspout.

13. The method of claim 11 further comprising attaching at least one clip to a lip of said downspout such that said first portion sets against a back wall of said downspout, said at least one clip coupled to said second portion.

14. The method of claim 13 further comprising said apparatus flexing in response to a force exerted between said at least one clip and said first portion setting on said back wall of said downspout, said force thereby making a more secure fit within said downspout.

15. The method of claim 11 further comprising micro diverting of said water flow with protrusions located on the surface of at least one portion of said apparatus.

16. The method of claim 15 further comprising maintaining micro diversion of said water flow by passing debris along furrows acting as said protrusions.

17. The method of claim 11 further comprising breaking away a portion of said first portion to adjust a length of said first portion.

18. An apparatus to reduce extraneous noise from a flow of water through a downspout, said apparatus comprising:
a first portion having a first diverting angle; and
a second portion coupled to said first portion and having a second diverting angle;
a third portion coupled between said first and second portions forming an angle which allows said first portion to reach up into a vertical section of said downspout;
a fourth portion coupled to said third portion, said fourth portion including at least one clip to attach to a lip of said downspout; and
a fifth portion coupled across parts of said first, second, and third portions, said fifth portion having surface details to micro-divert said water flow,
wherein said first diverting angle is less than said second diverting angle relative to a vertical direction of said water flow allowing an incremental diversion of said water flow, thereby reducing an impact of said water flow within said downspout.

19. The apparatus of claim 18 wherein said third portion forms an angle between said first and second portion which allows said first portion to reach up into a vertical section of said downspout.

20. The apparatus of claim 18 wherein said first and second diversion angles are formed when at least said third portion flexes in response to a force between said first portion on a back of said downspout and said fourth portion on a lip of said downspout.
